(19) United States
(12) Patent Application Publication
(10) Pub. No.: US 2012/0110456 A1
(43) Pub. Date: May 3, 2012

(54) INTEGRATED VOICE COMMAND MODAL USER INTERFACE

(75) Inventors: Vanessa Larco, Kirkland, WA (US); Alan T. Shen, Redmond, WA (US); Michael Han-Young Kim, Redmond, WA (US)

(73) Assignee: MICROSOFT CORPORATION, Redmond, WA (US)

(21) Appl. No.: 12/917,461

(22) Filed: Nov. 1, 2010

(51) Int. Cl. G06F 3/16

(52) U.S. Cl. 715/728

(57) ABSTRACT

A system and method are disclosed for providing a NUI system including a speech reveal mode where visual objects on a display having an associated voice command are highlighted. This allows a user to quickly and easily identify available voice commands, and also enhances an ability of a user to learn voice commands as there is a direct association between an object and its availability as a voice command.

### BACKGROUND

In the past, computing applications such as computer games and multimedia applications used controllers, remotes, keyboards, mice, or the like to allow users to manipulate game characters or other aspects of an application. More recently, computer games and multimedia applications have begun employing cameras and software gesture recognition engines to provide a natural user interface (“NUI”). With NUI, user gestures and speech are detected, interpreted and used to control game characters or other aspects of an application.

NUI systems allow users to interact with the system via verbal commands Currently, menus or new pages are displayed to the user that provide a list of the available commands. However, such menus occlude the original content that the user was trying to act on. If the list of commands is long, it may occlude the entire screen or direct the user to a different page, creating a disassociation of the command from its context. This detracts from the user experience with the NUI system.

### SUMMARY

The present technology, roughly described, relates to a multi-modal natural user interface system. In a first mode, a screen associated with the natural user interface displays graphical icons with which a user may interact using gestures and voice commands In a second, speech reveal mode, the screen highlights all graphical objects having an associated voice command The highlighted graphical object may be text so that, when a user speaks the highlighted text, an action associated with the verbal command is carried out. The highlighted graphical object may alternatively be an object other than text. The user may enter and exit the speech reveal mode with verbal commands, selection of an on-screen icon, or through performance of some physical gesture recognizable by the NUI system.

In one example, the present technology relates to a method of configuring a natural user interface including speech commands associated with one or more visual elements provided on a display. The method comprising the steps of: (a) displaying at least one visual element having an associated speech command performing some action in the natural user interface in connection with the at least one visual element; and (b) displaying a visual indicator associated with a visual element of the at least visual elements, the visual indicator indicating the visual element has an associated speech command and the visual indicator distinguishing the visual element from visual elements not having associated speech commands.

In a further example, the present technology relates to a computer-readable storage medium for programming a processor to perform a method of providing a multi-modal natural user interface including speech commands associated with one or more visual elements provided on a display. The method comprising the steps of: (a) displaying, during a normal mode of operation, at least one visual element having an associated speech command performing some action in the natural user interface in connection with the at least one visual element; (b) receiving an indication to switch from the normal mode of operation to a speech reveal mode; and (c) displaying, upon receipt of the indication in said step (b), a visual indicator associated with a visual element of the at least visual elements, the visual indicator indicating the visual element has an associated speech command.

In a further example, the present technology relates to a computer system having a graphical user interface and a natural user interface for interacting with the graphical user interface, and a method of providing the graphical user interface and the natural user interface, comprising: (a) displaying at least one visual element on the graphical user interface, the at least one visual element having an associated speech command performing some action in the natural user interface in connection with the at least one visual element; (b) receiving an indication via the natural user interface to enter a speech reveal mode; and (c) displaying, upon receipt of the indication in said step (b), the visual element with a highlight, the highlight indicating the visual element has an associated speech command.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an example embodiment of a target recognition, analysis, and tracking system.

FIG. 2 illustrates a further example embodiment of a target recognition, analysis, and tracking system.

FIG. 3 illustrates an example embodiment of a capture device that may be used in a target recognition, analysis, and tracking system.

FIG. 4 is an illustration of a screen display presenting a conventional system for revealing which commands are available as speech commands.

FIGS. 5A and 5B are a flowchart of the operation of an embodiment of the present system.

FIG. 6 is an illustration of a screen display where visual elements having associated speech commands are highlighted according to an embodiment of the present system.

FIG. 7 is an illustration of a screen display where textual and other objects having associated speech commands are highlighted according to an embodiment of the present system.

FIG. 8 is an illustration of a screen display where textual objects are added to graphical objects and the textual objects having associated speech commands are highlighted according to an embodiment of the present system.

FIG. 9 is illustration of a screen display where visual elements having associated speech commands are displayed without highlighting according to an embodiment of the present system.

FIG. 10A illustrates an example embodiment of a computing device that may be used to interpret one or more gestures in a target recognition, analysis, and tracking system.

FIG. 10B illustrates another example embodiment of a computing device that may be used to interpret one or more gestures in a target recognition, analysis, and tracking system.

### DETAILED DESCRIPTION

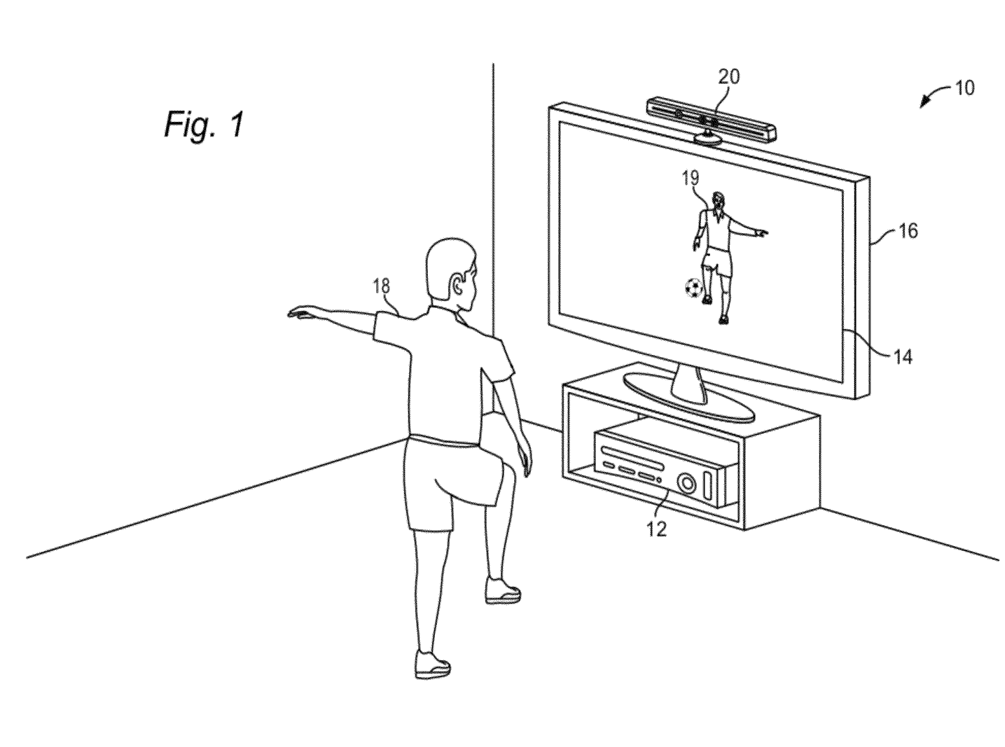

Embodiments of the present technology will now be described with reference to FIGS. 1-10B which in general relate to a NUI system including a speech reveal mode where visual objects on a display having an associated voice command are highlighted. This allows a user to quickly and easily identify available voice commands, and also enhances an ability of a user to learn voice commands as there is a direct association between an object and its availability as a voice command.

Referring initially to FIGS. 1-3, the hardware for implementing the present technology includes a target recognition, analysis, and tracking system 10 which may be used to recognize, analyze, and/or track a human target such as the user 18. Embodiments of the target recognition, analysis, and tracking system 10 include a computing environment 12 for executing a gaming or other application. The computing environment 12 may include hardware components and/or software components such that computing environment 12 may be used to execute applications such as gaming and non-gaming applications. In one embodiment, computing environment 12 may include a processor such as a standardized processor, a specialized processor, a microprocessor, or the like that may execute instructions stored on a processor readable storage device for performing processes described herein.

The system 10 further includes a capture device 20 for capturing image and audio data relating to one or more users and/or objects sensed by the capture device. In embodiments, the capture device 20 may be used to capture information relating to movements, gestures and speech of one or more users, which information is received by the computing environment and used to render, interact with and/or control aspects of a gaming or other application. Examples of the computing environment 12 and capture device 20 are explained in greater detail below.

Embodiments of the target recognition, analysis and tracking system 10 may be connected to an audio/visual device 16 having a display 14. The device 16 may for example be a television, a monitor, a high-definition television (HDTV), or the like that may provide game or application visuals and/or audio to a user. For example, the computing environment 12 may include a video adapter such as a graphics card and/or an audio adapter such as a sound card that may provide audio/visual signals associated with the game or other application. The audio/visual device 16 may receive the audio/visual signals from the computing environment 12 and may then output the game or application visuals and/or audio associated with the audio/visual signals to the user 18. According to one embodiment, the audio/visual device 16 may be connected to the computing environment 12 via, for example, an S-Video cable, a coaxial cable, an HDMI cable, a DVI cable, a VGA cable, a component video cable, or the like.

In embodiments, the computing environment 12, the A/V device 16 and the capture device 20 may cooperate to render an avatar or on-screen character 19 on display 14. In embodiments, the avatar 19 mimics the movements of the user 18 in real world space so that the user 18 may perform movements and gestures which control the movements and actions of the avatar 19 on the display 14.

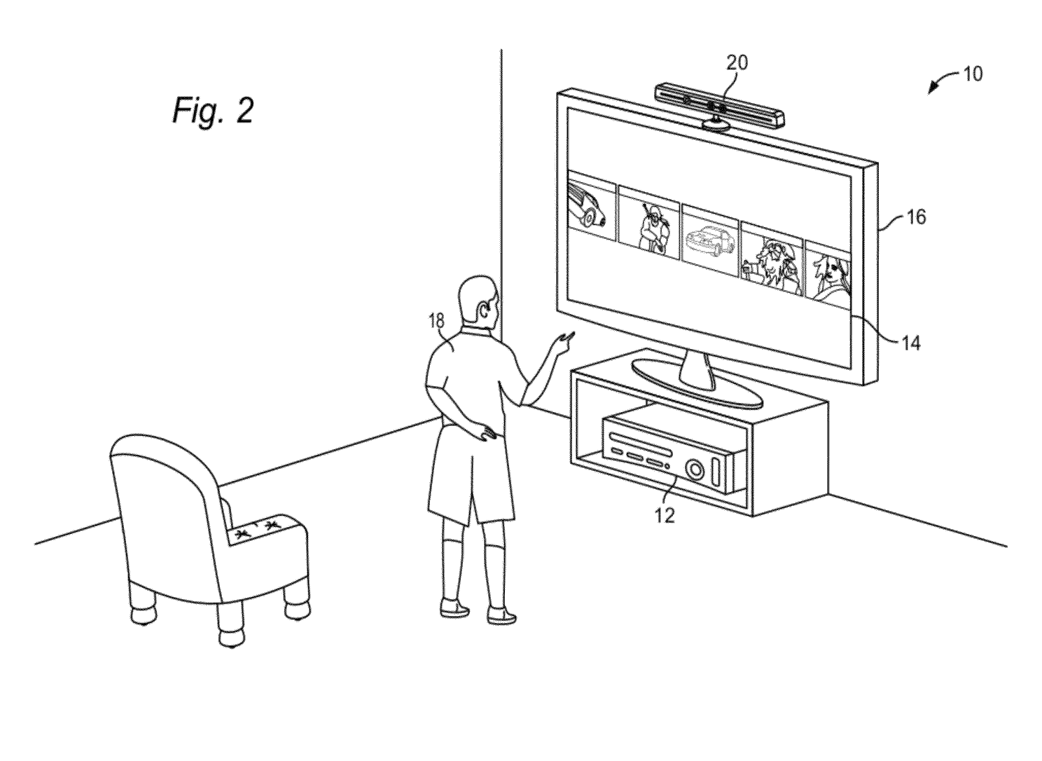

As shown in FIGS. 1 and 2, in an example embodiment, the application executing on the computing environment 12 may be a soccer game that the user 18 may be playing. For example, the computing environment 12 may use the audiovisual display 14 to provide a visual representation of an avatar 19 in form of a soccer player controlled by the user. The embodiment of FIG. 1 is one of many different applications which may be run on computing environment 12 in accordance with the present technology. The application running on computing environment 12 may be a variety of other gaming and non-gaming applications. Moreover, the system 10 may further be used to interpret user 18 movements and/or verbal commands as operating system and/or application controls that are outside the realm of games or the specific application running on computing environment 12. As one example shown in FIG. 2, a user may scroll through and control interaction with a variety of menu options presented on the display 14. Virtually any controllable aspect of an operating system and/or application may be controlled by movements of the user 18.

Suitable examples of a system 10 and components thereof are found in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; U.S. patent application Ser. No. 12/391,150, entitled “Standard Gestures,” filed Feb. 23, 2009; and U.S. patent application Ser. No. 12/474,655, entitled “Gesture Tool,” filed May 29, 2009.

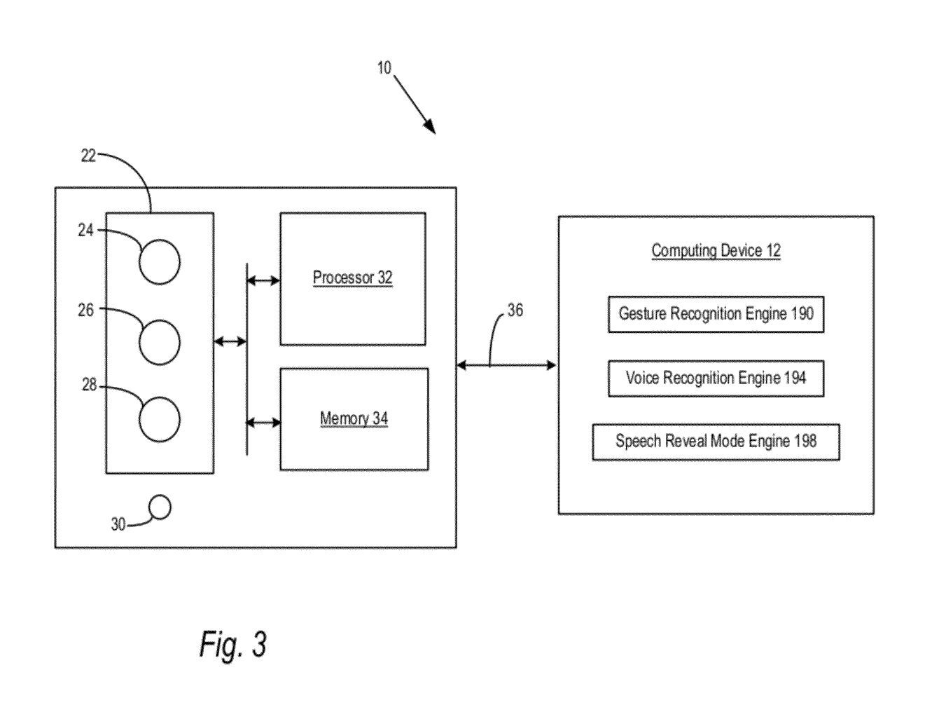

FIG. 3 illustrates an example embodiment of the capture device 20 that may be used in the target recognition, analysis, and tracking system 10. In an example embodiment, the capture device 20 may be configured to capture video having a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 3, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 3, according to an example embodiment, the image camera component 22 may include an IR light component 24, a 3-D depth camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28.

In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as a grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information. In another example embodiment, the capture device 20 may use point cloud data and target digitization techniques to detect features of the user.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 3, in one embodiment, the memory component 34 may be a separate component in communication with the image camera component 22 and the processor 32. According to another embodiment, the memory component 34 may be integrated into the processor 32 and/or the image camera component 22.

As shown in FIG. 3, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. A variety of known techniques exist for determining whether a target or object detected by capture device 20 corresponds to a human target. Skeletal mapping techniques may then be used to determine various spots on that user's skeleton, joints of the hands, wrists, elbows, knees, nose, ankles, shoulders, and where the pelvis meets the spine. Other techniques include transforming the image into a body model representation of the person and transforming the image into a mesh model representation of the person.

The skeletal model may then be provided to the computing environment 12 such that the computing environment may perform a variety of actions. The computing environment may further determine which controls to perform in an application executing on the computer environment based on, for example, gestures of the user that have been recognized from the skeletal model. For example, as shown, in FIG. 3, the computing environment 12 may include a gesture recognition engine 190 for determining when the user has performed a predefined gesture. Various embodiments of the gesture recognition engine 190 are described in the above incorporated applications. The computing environment 12 may further include a speech recognition engine 196 for recognizing speech commands, and a speech reveal mode engine 198 for highlighting visual objects having associated speech commands. Portions, or all, of the gesture recognition engine 190, speech recognition engine 194 and/or speech reveal mode engine 198 may be resident on capture device 20 and executed by the processor 33 in further embodiments.

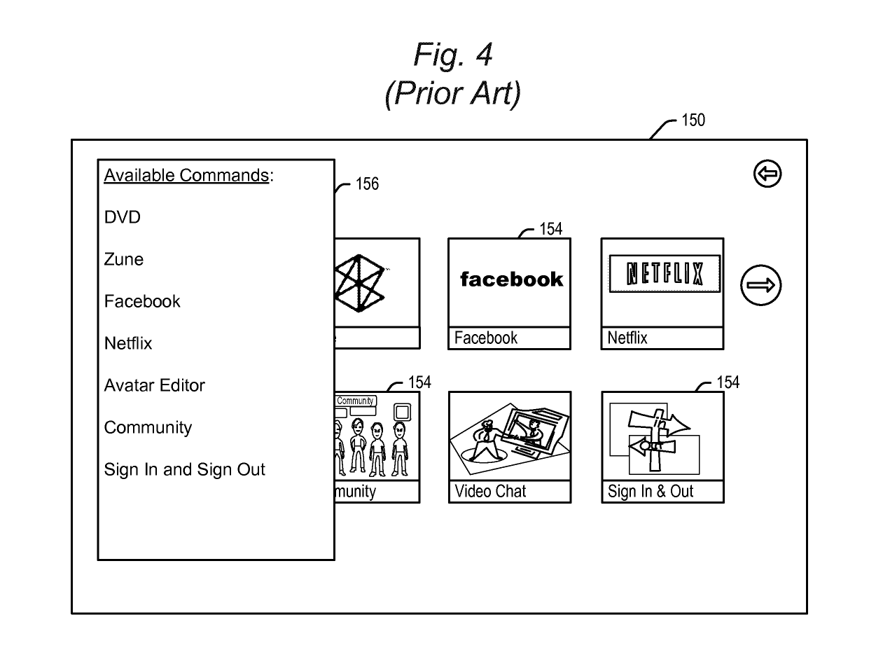

As discussed in the Background section, conventional systems have a speech reveal mode, but these systems work by displaying a menu or additional pages to the user. An example of a conventional system is shown in FIG. 4, which shows an illustration of a screen display 150 having visual elements 154. FIG. 4 further illustrates a menu 156 showing which verbal commands are available for the visual elements 154 displayed on screen display 150. Presenting the menu 156 covers at least a portion of the screen display 150 and prevents the user from being able to see the content behind the menu 156. Moreover, listing the available speech commands on a separate menu disassociates the speech command from the element 154 having the speech command Studies show this disassociation makes it harder to remember the speech commands.

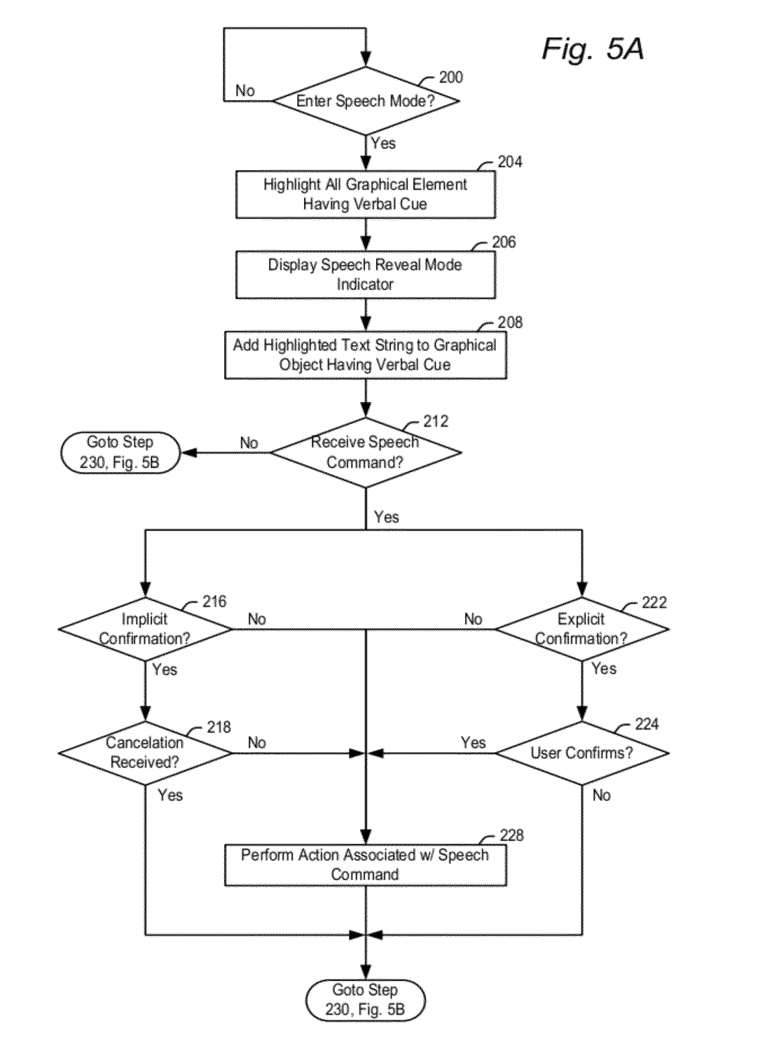

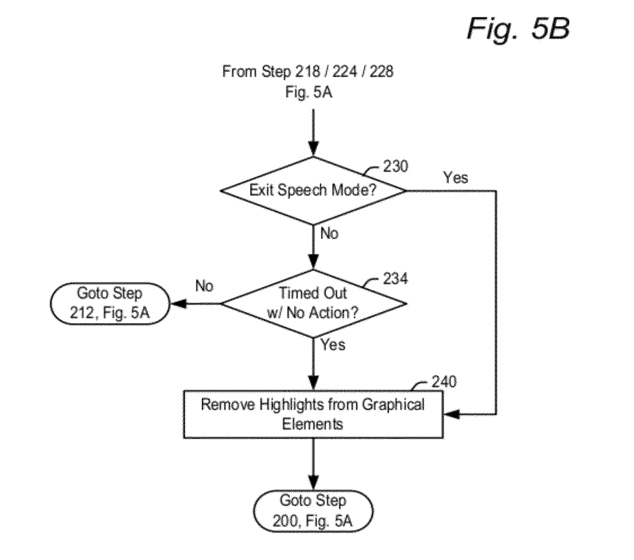

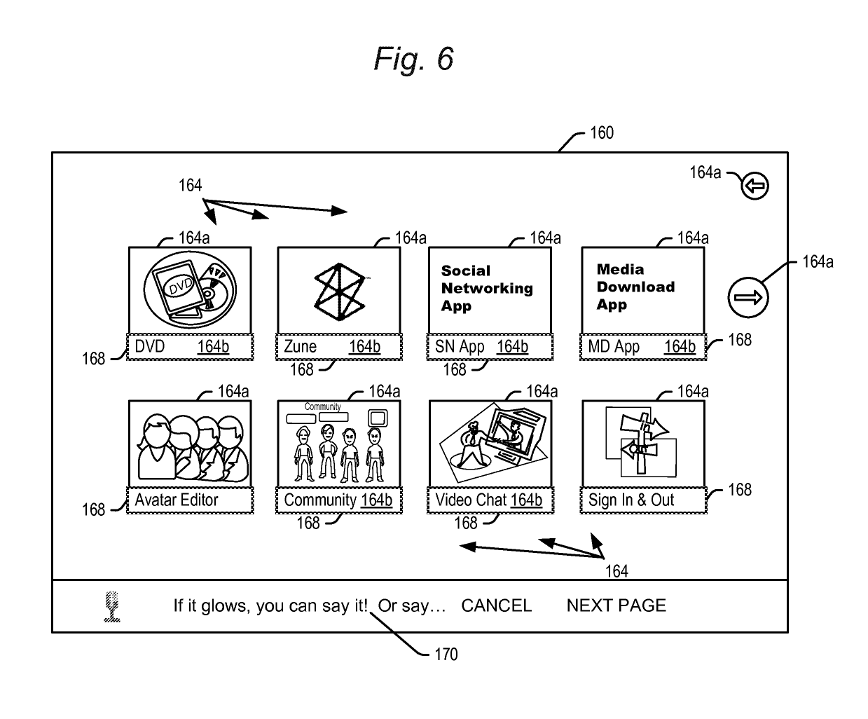

Thus, in accordance with the present system, the availability of speech commands is integrated into the main screen display. Sample embodiments of the present system are now explained with reference to the flowchart of FIGS. 5A and 5B and the screen illustrations of FIGS. 6 through 8. In one embodiment the present technology provides a multi-modal system. That is, the user is free to select whether or not the system displays available speech commands. During a “normal mode” of operation, a user may not wish available speech commands to be shown on the display 14. Thus, in the normal mode, the display 14 does not provide an indication of available speech commands. The user may interact with the system using physical gestures as controls. The user may also use speech commands in the normal mode of operation, even though the availability of specific speech commands is not shown.

Alternatively, there may come a time when the user wishes to see which speech commands are available. The user would thus enter the “speech reveal mode” as explained below. In further embodiments, it is contemplated that the system operate in a single mode, where the specifically available speech commands are always indicated on the display 14.

Referring now to the flowchart of FIG. 5A, in a multi-modal system, a user may enter the speech reveal mode in a step 200 by performing some initiation action. This action may be speaking some verbal command, for example a predefined word, known to the computing device for triggering the speech reveal mode. When the verbal command is spoken and interpreted by the voice recognition engine 194, the speech reveal mode engine 198 may run. It is understood that the initiation action may be other than a verbal command For example, the initiation action may be physical gesture known to the gesture recognition engine 190 for triggering the speech reveal mode. In further embodiments, an icon may be provided on display 14, selection of which initiates the speech reveal mode.

Upon initiation of the speech reveal mode in step 200, the speech reveal mode engine will provide a visual indicator on visual elements on the display having an associated speech command in step 204. An example of this is shown in FIG. 6, which illustrates a graphical user interface, or screen display, 160 having visual elements 164 including graphical objects 164a and textual objects 164b. In an embodiment, the speech reveal mode engine 198 provides a visual indicator 168 around all textual objects 164b having an associated speech command. In embodiments the text within the textual objects 164b is what the user needs to speak to have the action associated with a given speech command performed. This action may involve launching an associated application, though the speech commands may have other associated actions in further embodiments.

Having a visual indicator 168 associated with a specific text object 164b makes it clear what the user needs to speak in order to perform a given speech command. However, the visual indicator 168 may be associated with other visual elements in further embodiments. FIG. 6 shows several graphical objects 164a and text objects 164b being contiguous with each other. In such embodiments, the visual indicator may be around both the graphical and text objects (around the outer periphery of the objects together).

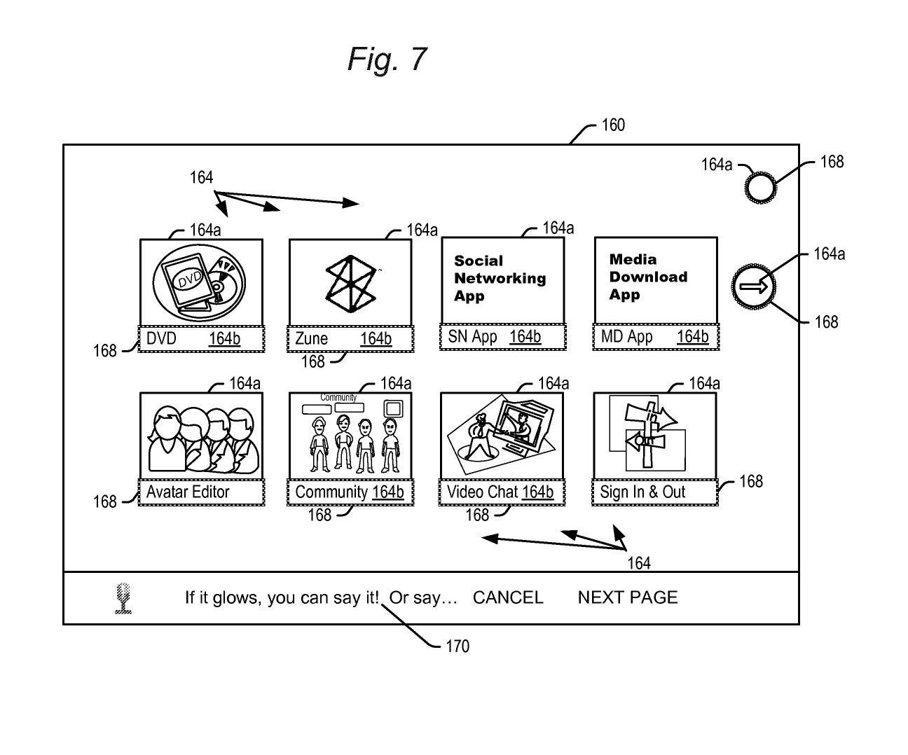

Moreover, the visual indicator 168 may around a graphical object alone. For example, as shown in FIG. 7, the screen display 160 may include graphical back and forward buttons (upper right of the screen display). These graphical objects may include a visual indicator 168 around their periphery.

FIGS. 6 and 7 illustrate one example of how graphical objects and/or graphical text may include a visual indicator 168 to indicate that the object has an associated speech command. However, it is understood that any graphical object and/or graphical text displayed on display 14 may include a visual indicator 168 to indicate that there is a speech command associated with that object.

In embodiments, the visual indicator 168 may be highlight around the border of an visual element 164 (graphical object 164a and/or text object 164b). However, it is understood that the visual indicator 168 may be a variety of other indicators in further embodiments. For example, an interior of a visual element may additionally or alternatively be highlighted. As a further example, a border and/or interior of a visual element may be provided with a color, or shaded, or may be given different visual effects, such as flashing on the display. In embodiments, the visual indicator 168 according to any of these examples may only be visible upon a user “hovering” over a visual element 164. This may for example be useful in an embodiment that is not multi-modal (i.e., always in speech reveal mode). A user may hover over an object by directing a cursor with his or her body movements as described above. The visual indicator may be a variety of other effects which distinguish visual elements having an associated speech command from those visual elements that do not.

Referring again to the flowchart of FIG. 5A, in step 206, the speech reveal mode engine 198 may also display a banner or other indication that the system is in the speech reveal mode. For example, as shown on FIGS. 6 and 7, the visual display 160 may include a banner 170 telling the user that any of the highlighted visual elements have an associated speech command. The step 206 and banner 170 may be omitted in further embodiments of the present system.

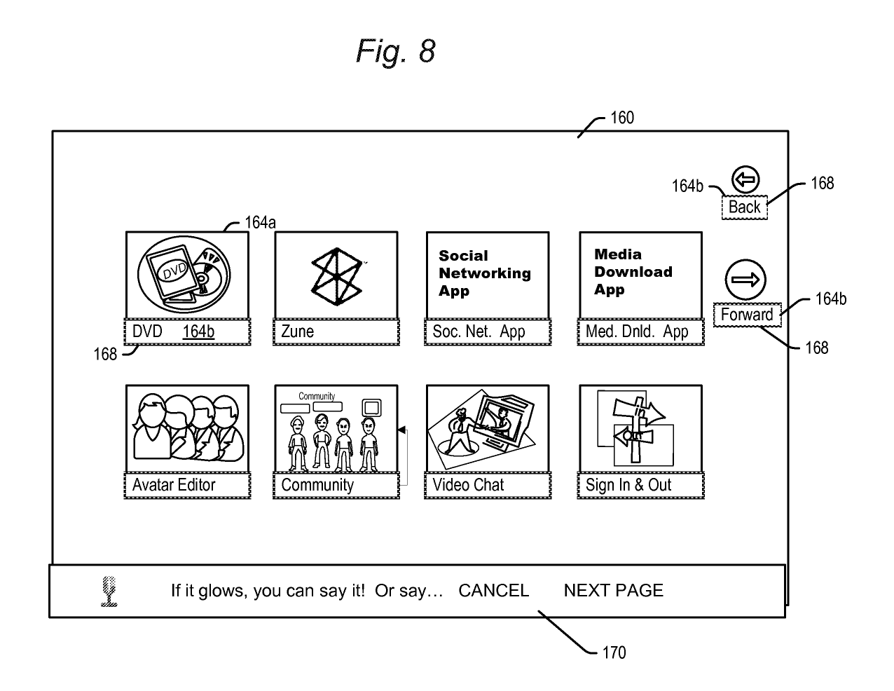

In certain embodiments, a displayed graphical object 164a may have no associated text object 164b, and yet still have an associated speech command. For example, the back and forward buttons on FIGS. 6 and 7 have no associated text object 164b, but may still be spoken as verbal commands. For graphical objects like this, the speech reveal mode engine 198 may add a text object 164b, and provide a visual indicator around the graphical object 164a and/or text object 164 in step 208. Such an example is shown in FIG. 8. It is understood that a wide variety of other graphical objects may have associated speech commands, but no associated text object when in normal mode. When the user enters the speech reveal mode, text objects may be added to such graphical objects and then a visual indicator 168 may be provided to the text and/or graphical object. The step 208 of adding a text object to graphical objects having speech commands may be omitted in further embodiments.

In step 212, the system looks for a speech command If none is received (or none is understood), the system looks to whether the speech reveal mode is to terminate, as explained below with reference to step 230, FIG. 5B. However, if a recognized speech command is received in step 212, the system may prompt a user to implicitly or explicitly confirm the speech command in steps 216 and 222, respectively. Some speech commands may prompt a user for implicit confirmation while others would prompt a user for explicit confirmation. Whether a given speech command is to be implicitly or explicitly confirmed may be predefined within the system, based on the speech command. Some speech commands may require neither implicit nor explicit confirmation. For such speech commands, the system may proceed from steps 216/222 to step 228 of performing the action associated with the speech command.

In further embodiments, steps 216 through 224 of confirming a speech command may be omitted altogether, in which case all received speech commands are automatically performed without confirmation. Further embodiments may operate with only implicit confirmation (no explicit confirmation) or explicit confirmation (no implicit confirmation).

Where a given speech command is to be implicitly confirmed in step 216, after the speech command is recognized in step 212, the system may prompt a user for implicit confirmation. An implicit confirmation is one where the action associated with the speech command will automatically be performed unless the user intervenes. For example, the system will display (for example in banner 170), “[Application x] being launched,” with the user having the option to cancel (for example by saying the word “cancel” or performing some other cancellation action). The system may wait a predetermined period of time in step 218 for the cancelation, and if no such cancelation is received, the system may proceed to step 228 of performing the action associated with the speech command. On the other hand, where a user indicates a desire to cancel the speech command within the predetermined period of time, the system skips step 228, and looks to whether the speech reveal mode is to terminate, as explained below with reference to step 230, FIG. 5B.

Where a given speech command is to be explicitly confirmed in step 222, after the speech command is recognized in step 212, the system may prompt a user for explicit confirmation of the command. An implicit confirmation is one where some user action is required or the speech command will not be performed. For example, the system will display (for example in banner 170), “Do you wish to launch [Application x]?,” and prompting the user to provide a yes or no indication (for example by saying the words “yes” or “no” or performing some other affirmative or negative indication. The system may wait a predetermined period of time in step 224 for the yes or no indication as to whether to perform the speech command. If no indication is received within a predetermined period of time, the system may skip step 228, and look to whether the speech reveal mode is to terminate, as explained below with reference to step 230, FIG. 5B. One the other hand, if the user confirms the speech command in step 224, the system performs the action associated with the speech command in step 228.

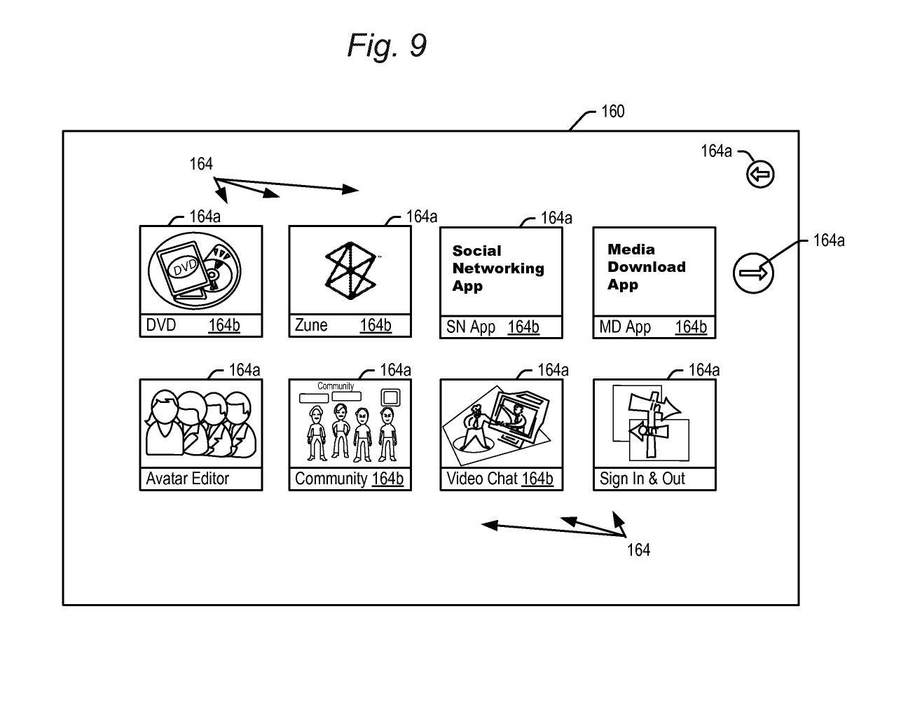

After performing the action in step 228, or skipping the action if it is canceled in step 218 or not confirmed in step 224, the system next checks in step 230 (FIG. 5B) whether a termination command is received. In step 210, the speech reveal mode engine 198 may look for a termination command which ends the speech reveal mode and returns to normal mode. The termination command may be verbal, a physical gesture, or an icon on display screen 160. If such a termination command is detected in step 230, any visual indicators 168, banner 170 (and text boxes which may have been added) may be removed so that the display screen 160 again runs in normal mode. FIG. 9 shows an example of the screen display running in normal mode.

If no affirmative termination command is received, the system may nevertheless terminate the speech reveal mode if some predetermined period of time has passed without the user taking any action. In step 234, the speech reveal mode engine 198 may check whether a predetermined period of time has elapsed. If not, the system may return to step 212 in FIG. 5A to look for another speech command. On the other hand, if the predetermined period has timed out in step 234, the visual indicators 168, banner 170 (and text boxes which may have been added) may be removed so that the display screen 160 again runs in normal mode as shown in FIG. 9.

A system of integrating visual indicators directly on visual elements having speech commands provides several advantages. First, such as system does not obscure other graphical elements on the display. Moreover, by integrating the indicator directly on the visual element, there is no disassociation of the speech command from the visual element (as happens in conventional systems using menus and additional pages to set out available speech commands). As such, users learn which visual elements have associated speech commands more quickly and easily.

The FIGS. 6-8 show several examples where verbal commands may be associated with launching applications. A graphical object for signing in and out of the system 10 may also have a speech command and receive a visual indicator 168, as shown for example in the lower left corner of the screen display 160 in FIGS. 6-8. Moreover, it is understood that the present system may be used within applications to indicate visual elements having speech commands. For example, in a gaming application, displayed objects which are part of a game may have associated speech commands Examples include a bat, ball, gun, card, body part, and a wide variety of other objects. In such situations, a user may enter the speech reveal mode, whereupon visual indicators may be added to any such object as described above.

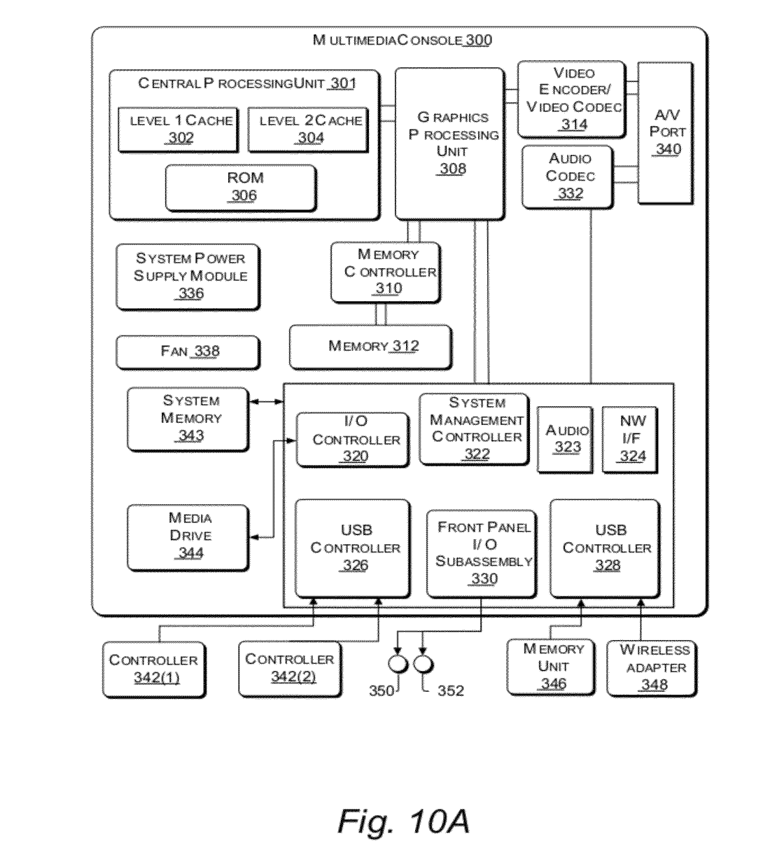

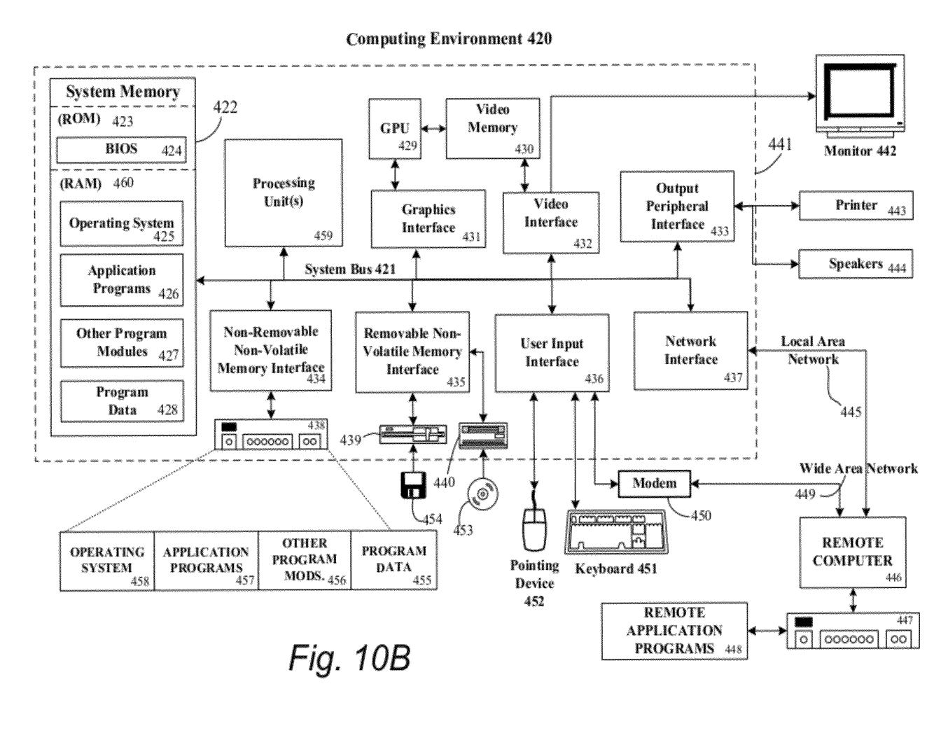

FIG. 10A illustrates an example embodiment of a computing environment, such as for example computing system 12, that may be used to run the gesture recognition engine 190, the speech recognition engine 194 and the speech reveal mode engine 198. The computing device 12 may be a multimedia console 300, such as a gaming console. As shown in FIG. 10A, the multimedia console 300 has a central processing unit (CPU) 301 having a level 1 cache 302, a level 2 cache 304, and a flash ROM 306. The level 1 cache 302 and a level 2 cache 304 temporarily store data and hence reduce the number of memory access cycles, thereby improving processing speed and throughput. The CPU 301 may be provided having more than one core, and thus, additional level 1 and level 2 caches 302 and 304. The flash ROM 306 may store executable code that is loaded during an initial phase of a boot process when the multimedia console 300 is powered ON.

A graphics processing unit (GPU) 308 and a video encoder/video codec (coder/decoder) 314 form a video processing pipeline for high speed and high resolution graphics processing. Data is carried from the GPU 308 to the video encoder/video codec 314 via a bus. The video processing pipeline outputs data to an A/V (audio/video) port 340 for transmission to a television or other display. A memory controller 310 is connected to the GPU 308 to facilitate processor access to various types of memory 312, such as, but not limited to, a RAM.

The multimedia console 300 includes an I/O controller 320, a system management controller 322, an audio processing unit 323, a network interface controller 324, a first USB host controller 326, a second USB host controller 328 and a front panel I/O subassembly 330 that are preferably implemented on a module 318. The USB controllers 326 and 328 serve as hosts for peripheral controllers 342(1)-342(2), a wireless adapter 348, and an external memory device 346 (e.g., flash memory, external CD/DVD ROM drive, removable media, etc.). The network interface 324 and/or wireless adapter 348 provide access to a network (e.g., the Internet, home network, etc.) and may be any of a wide variety of various wired or wireless adapter components including an Ethernet card, a modem, a Bluetooth module, a cable modem, and the like.

System memory 343 is provided to store application data that is loaded during the boot process. A media drive 344 is provided and may comprise a DVD/CD drive, hard drive, or other removable media drive, etc. The media drive 344 may be internal or external to the multimedia console 300. Application data may be accessed via the media drive 344 for execution, playback, etc. by the multimedia console 300. The media drive 344 is connected to the I/O controller 320 via a bus, such as a Serial ATA bus or other high speed connection (e.g., IEEE 1394).

The system management controller 322 provides a variety of service functions related to assuring availability of the multimedia console 300. The audio processing unit 323 and an audio codec 332 form a corresponding audio processing pipeline with high fidelity and stereo processing. Audio data is carried between the audio processing unit 323 and the audio codec 332 via a communication link. The audio processing pipeline outputs data to the A/V port 340 for reproduction by an external audio player or device having audio capabilities.

The front panel I/O subassembly 330 supports the functionality of the power button 350 and the eject button 352, as well as any LEDs (light emitting diodes) or other indicators exposed on the outer surface of the multimedia console 300. A system power supply module 336 provides power to the components of the multimedia console 300. A fan 338 cools the circuitry within the multimedia console 300.

The CPU 301, GPU 308, memory controller 310, and various other components within the multimedia console 300 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 300 is powered ON, application data may be loaded from the system memory 343 into memory 312 and/or caches 302, 304 and executed on the CPU 301. The application may present a graphical user interface that provides a consistent user experience when navigating to different media types available on the multimedia console 300. In operation, applications and/or other media contained within the media drive 344 may be launched or played from the media drive 344 to provide additional functionalities to the multimedia console 300.

The multimedia console 300 may be operated as a standalone system by simply connecting the system to a television or other display. In this standalone mode, the multimedia console 300 allows one or more users to interact with the system, watch movies, or listen to music. However, with the integration of broadband connectivity made available through the network interface 324 or the wireless adapter 348, the multimedia console 300 may further be operated as a participant in a larger network community.

When the multimedia console 300 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of the application resolution. A scaler may be used to set this resolution such that the need to change frequency and cause a TV resynch is eliminated.

After the multimedia console 300 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 301 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 342(1) and 342(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches. The cameras 26, 28 and capture device 20 may define additional input devices for the console 300.

FIG. 10B illustrates another example embodiment of a computing environment 720 that may be the computing environment 12 shown in FIGS. 1A-2 used to interpret one or more positions and motions in a target recognition, analysis, and tracking system. The computing system environment 720 is only one example of a suitable computing environment and is not intended to suggest any limitation as to the scope of use or functionality of the presently disclosed subject matter. Neither should the computing environment 720 be interpreted as having any dependency or requirement relating to any one or combination of components illustrated in the Exemplary operating environment 720. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 10B, the computing environment 420 comprises a computer 441, which typically includes a variety of computer readable media. Computer readable media can be any available media that can be accessed by computer 441 and includes both volatile and nonvolatile media, removable and non-removable media. The system memory 422 includes computer storage media in the form of volatile and/or nonvolatile memory such as ROM 423 and RAM 460. A basic input/output system 424 (BIOS), containing the basic routines that help to transfer information between elements within computer 441, such as during start-up, is typically stored in ROM 423. RAM 460 typically contains data and/or program modules that are immediately accessible to and/or presently being operated on by processing unit 459. By way of example, and not limitation, FIG. 10B illustrates operating system 425, application programs 426, other program modules 427, and program data 428. FIG. 10B further includes a graphics processor unit (GPU) 429 having an associated video memory 430 for high speed and high resolution graphics processing and storage. The GPU 429 may be connected to the system bus 421 through a graphics interface 431.

The computer 441 may also include other removable/non-removable, volatile/nonvolatile computer storage media. By way of example only, FIG. 10B illustrates a hard disk drive 438 that reads from or writes to non-removable, nonvolatile magnetic media, a magnetic disk drive 439 that reads from or writes to a removable, nonvolatile magnetic disk 454, and an optical disk drive 440 that reads from or writes to a removable, nonvolatile optical disk 453 such as a CD ROM or other optical media. Other removable/non-removable, volatile/nonvolatile computer storage media that can be used in the Exemplary operating environment include, but are not limited to, magnetic tape cassettes, flash memory cards, digital versatile disks, digital video tape, solid state RAM, solid state ROM, and the like. The hard disk drive 438 is typically connected to the system bus 421 through a non-removable memory interface such as interface 434, and magnetic disk drive 439 and optical disk drive 440 are typically connected to the system bus 421 by a removable memory interface, such as interface 435.

The drives and their associated computer storage media discussed above and illustrated in FIG. 10B, provide storage of computer readable instructions, data structures, program modules and other data for the computer 441. In FIG. 10B, for example, hard disk drive 438 is illustrated as storing operating system 458, application programs 457, other program modules 456, and program data 455. Note that these components can either be the same as or different from operating system 425, application programs 426, other program modules 427, and program data 428. Operating system 458, application programs 457, other program modules 456, and program data 455 are given different numbers here to illustrate that, at a minimum, they are different copies. A user may enter commands and information into the computer 441 through input devices such as a keyboard 451 and a pointing device 452, commonly referred to as a mouse, trackball or touch pad. Other input devices (not shown) may include a microphone, joystick, game pad, satellite dish, scanner, or the like. These and other input devices are often connected to the processing unit 459 through a user input interface 436 that is coupled to the system bus, but may be connected by other interface and bus structures, such as a parallel port, game port or a universal serial bus (USB). The cameras 26, 28 and capture device 20 may define additional input devices for the console 400. A monitor 442 or other type of display device is also connected to the system bus 421 via an interface, such as a video interface 432. In addition to the monitor, computers may also include other peripheral output devices such as speakers 444 and printer 443, which may be connected through an output peripheral interface 433.

The computer 441 may operate in a networked environment using logical connections to one or more remote computers, such as a remote computer 446. The remote computer 446 may be a personal computer, a server, a router, a network PC, a peer device or other common network node, and typically includes many or all of the elements described above relative to the computer 441, although only a memory storage device 447 has been illustrated in FIG. 10B. The logical connections depicted in FIG. 10B include a local area network (LAN) 445 and a wide area network (WAN) 449, but may also include other networks. Such networking environments are commonplace in offices, enterprise-wide computer networks, intranets and the Internet.

When used in a LAN networking environment, the computer 441 is connected to the LAN 445 through a network interface or adapter 437. When used in a WAN networking environment, the computer 441 typically includes a modem 450 or other means for establishing communications over the WAN 449, such as the Internet. The modem 450, which may be internal or external, may be connected to the system bus 421 via the user input interface 436, or other appropriate mechanism. In a networked environment, program modules depicted relative to the computer 441, or portions thereof, may be stored in the remote memory storage device. By way of example, and not limitation, FIG. 10B illustrates remote application programs 448 as residing on memory device 447. It will be appreciated that the network connections shown are Exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed:

1. A method of configuring a natural user interface including speech commands associated with one or more visual elements provided on a display, comprising:
(a) displaying at least one visual element having an associated speech command performing some action in the natural user interface in connection with the at least one visual element; and
(b) displaying a visual indicator associated with a visual element of the at least visual elements, the visual indicator indicating the visual element has an associated speech command and the visual indicator distinguishing the visual element from visual elements not having associated speech commands.

2. The method of claim 1, wherein said step (a) of displaying at least one visual element having an associated speech command comprises the step of displaying a text object, said step (b) displaying the visual indicator associated with the text object.

3. The method of claim 1, wherein said step (a) of displaying at least one visual element having an associated speech command comprises the step of displaying a graphical object, said step (b) displaying the visual indicator associated with the graphical object.

4. The method of claim 1, wherein said step (a) of displaying at least one visual element having an associated speech command comprises the step of displaying a text object and an associated graphical object, said step (b) displaying the visual indicator associated with the text object and graphical object.

5. The method of claim 1, wherein said step (a) of displaying at least one visual element having an associated speech command comprises the step of displaying a graphical object, the method further comprising the step (c) of adding a text object associated with the graphical object and displaying the visual indicator associated with the added text object.

6. The method of claim 1, wherein said step (b) of displaying the visual indicator associated with the visual element comprises the step of highlighting a border of the visual element.

7. The method of claim 1, wherein said step (b) of displaying the visual indicator associated with the visual element comprises the step of highlighting an interior of the visual element.

8. The method of claim 1, wherein said step (b) of displaying the visual indicator associated with the visual element comprises the step of providing a distinctive color to the interior and/or border of the visual element.

9. The method of claim 1, wherein said step (b) of displaying the visual indicator associated with the visual element comprises the step of displaying the visual indicator only upon a user hovering over the visual element.

10. A computer-readable storage medium for programming a processor to perform a method of providing a multi-modal natural user interface including speech commands associated with one or more visual elements provided on a display, comprising:
(a) displaying, during a normal mode of operation, at least one visual element having an associated speech command performing some action in the natural user interface in connection with the at least one visual element;
(b) receiving an indication to switch from the normal mode of operation to a speech reveal mode; and
(c) displaying, upon receipt of the indication in said step (b), a visual indicator associated with a visual element of the at least visual elements, the visual indicator indicating the visual element has an associated speech command.

11. The computer-readable storage medium of claim 10, wherein said step (a) of displaying at least one visual element having an associated speech command comprises the step of displaying at least one of a text object and a graphical object, said step (c) displaying the visual indicator associated with the text and/or graphical object.

12. The computer-readable storage medium of claim 10, wherein said step (a) of displaying at least one visual element having an associated speech command comprises the step of displaying a graphical object, the method further comprising the step (d) of adding a text object associated with the graphical object and displaying the visual indicator associated with the added text object when in the speech reveal mode.

13. The computer-readable storage medium of claim 10, wherein said step (c) of displaying the visual indicator associated with the visual element comprises the step of highlighting a border and/or interior of the visual element.

14. The computer-readable storage medium of claim 10, wherein said step (c) of displaying the visual indicator associated with the visual element comprises the step of providing a distinctive color to the interior and/or border of the visual element.

15. In a computer system having a graphical user interface and a natural user interface for interacting with the graphical user interface, a method of providing the graphical user interface and the natural user interface, comprising:
(a) displaying at least one visual element on the graphical user interface, the at least one visual element having an associated speech command performing some action in the natural user interface in connection with the at least one visual element;
(b) receiving an indication via the natural user interface to enter a speech reveal mode; and
(c) displaying, upon receipt of the indication in said step (b), the visual element with a highlight, the highlight indicating the visual element has an associated speech command

16. The method of claim 15, further comprising the steps of:
(d) receiving a speech command;
(e) identifying an action associated with the speech command; and
(f) performing the action associated with the speech command.

17. The method of claim 16, wherein said step (d) comprises at least one of: launching an application represented by the visual element; performing an action associated with an object displayed on the graphical user interface.

18. The method of claim 15, further comprising the step (g) of removing the highlight from the visual element upon receipt of an indication to end the speech reveal mode.

19. The method of claim 15, wherein said step (a) of displaying at least one visual element having an associated speech command comprises the step of displaying at least one of a text object and a graphical object, said step (c) displaying the visual indicator associated with the text and/or graphical object.

20. The method of claim 15, further comprising the step (h) of displaying a banner indicating that the system is running in speech reveal mode upon receiving the indication to run in speech reveal mode in said step (b).
